(19) United States
(12) Patent Application Publication
(10) Pub. No.: US 2011/0205191 A1
(43) Pub. Date: Aug. 25, 2011

(54) ELECTROMAGNETIC SENSING DEVICE HAVING MULTI-POINT TOUCH FUNCTION

(76) Inventors: Tao Hou, Beijing (CN); Honggang Wang, Beijing (CN); Jie Wang, Beijing (CN); Hang Yin, Beijing (CN)

(21) Appl. No.: 13/120,815

(22) PCT Filed: Sep. 8, 2009
(86) PCT No.: PCT/CN2009/073814

§ 371 Date: Mar. 24, 2011

(30) Foreign Application Priority Data
Sep. 26, 2008 (CN) 200810223338.8

(51) Int. Cl. G06F 3/033

(52) U.S. Cl. 345/179

(57) ABSTRACT

An electromagnetic sensing device having a multi-point touch function comprises electromagnetic pens (101) for inputting graphics and an electromagnetic sensing board for detecting trace information of the inputted graphics. Each of the electromagnetic pens (101) has a resonance circuit provided therein, and the electromagnetic sensing board has an electromagnetic wave transmitter (102), an electromagnetic wave receiver (105), a controller (109) and an electric wave frequency switching unit (103) provided therein. The electric wave frequency switching unit (103) of the electromagnetic sensing board receives an instruction from the controller (109) to control the electromagnetic wave transmitter (102) to transmit electromagnetic waves at different frequencies, and the electromagnetic pens (101) generate electromagnetic resonance waves at respective resonance frequencies. The electromagnetic wave receiver (105) receives the electromagnetic resonance waves at the respective resonance frequencies so that the trace information of the electromagnetic pens (101) having the respective resonance frequencies is detected. With this electromagnetic sensing device, it is possible to achieve a wireless and passive electromagnetic sensing device having the multi-point touch function.

### FIELD OF INVENTION

The present invention generally relates to the field of input from computer periphery devices, and particularly, to an electromagnetic sensing device enabling handwriting input, and more particularly, to an electromagnetic sensing device enabling multi-point touch input.

### BACKGROUND

Nowadays, the electromagnetic type touch technology is attracting more and more interests due to its advantages such as high positioning precision, capability of obtaining information on tilt angle and pressure of a touch pen, and having no impacts on the screen display quality when applied to the display field, and finds wide applications in devices such as handwriting computers, drawing boards, handwriting boards, mobile phones and electronic reading device. An electromagnetic sensing device adopting the electromagnetic type touch technology comprises an electromagnetic sensing board and an electromagnetic pen, wherein the electromagnetic sensing board has an electromagnetic wave transmitter and an electromagnetic wave receiver provided therein and the electromagnetic pen has a resonance circuit provided therein. The electromagnetic wave transmitter transmits an electromagnetic wave at a single frequency. When the electromagnetic pen approaches the electromagnetic sensing board, the resonance circuit therein resonates to reflect the electromagnetic wave to the electromagnetic sensing board, and the electromagnetic wave receiver receives the reflected electromagnetic wave having the same resonance frequency. Accordingly, the electromagnetic sensing board detects relevant information of the electromagnetic pen such as its coordinates, tilt angle, pressure and velocity.

However, the electromagnetic sensing device just enables the single-point touch function, that is, the electromagnetic sensing board of the electromagnetic sensing device transmits the electromagnetic wave at the single frequency, and can detect only the electromagnetic pen which produces the same resonance frequency. As a result, only one matching electromagnetic pen can work in an active area of the electromagnetic sensing board, but other electromagnetic pens at other frequencies cannot work. Thus, the function thereof is limited.

### SUMMARY OF THE INVENTION

In view of the above defects, the present invention aims to provide an electromagnetic sensing board capable of transmitting electromagnetic waves at different frequencies to detect trace information of electromagnetic pens of different frequencies, so as to achieve an electromagnetic sensing device having the multi-point touch function based on frequency switching.

According to an aspect of the invention, there is provided an electromagnetic sensing device having a multi-point touch function, comprising electromagnetic pens and an electromagnetic sensing board, each of the electromagnetic pens having a resonance circuit provided therein, and the electromagnetic sensing board having an electromagnetic wave transmitter, an electromagnetic wave receiver, a controller and an electric wave frequency switching unit provided therein, wherein: the detection of input traces of the electromagnetic pens on the electromagnetic sensing board is done by transmitting and receiving of electromagnetic waves between the electromagnetic sensing board and the electromagnetic pens; the electric wave frequency switching unit of the electromagnetic sensing board receives an instruction from the controller to control the electromagnetic wave transmitter to transmit electromagnetic waves at different frequencies; the electromagnetic pens generate electromagnetic resonance waves at respective resonance frequencies; and the electromagnetic wave receiver receives the electromagnetic resonance waves at the respective resonance frequencies so that the controller detects trace information of the electromagnetic pens having the respective resonance frequencies.

The electromagnetic sensing board further has an amplifier, a phase angle detector, an amplitude detector and an integrator provided therein. The electromagnetic wave receiver receives the electromagnetic resonance wave signals reflected from the electromagnetic pens respectively. The received electromagnetic resonance wave signals are amplified by the amplifier to be inputted to the phase angle detector and the amplitude detector respectively for detecting their respective phase angles and amplitudes, and then inputted through the integrator to the controller, which detects the trace information of the respective electromagnetic pens and sends it to a computer.

According to an embodiment of the invention, the electromagnetic sensing board repeatedly detects the electromagnetic pens having the different resonance frequencies sequentially, and obtains the trace information of the respective electromagnetic pens having the different resonance frequencies before sends it to the computer.

According to a further embodiment of the invention, the electromagnetic sensing board repeatedly detects the electromagnetic pens having the different resonance frequencies alternately. The electromagnetic sensing board obtains the trace information of the electromagnetic pen having a first resonance frequency and sends it to the computer before it obtains the trace information of the electromagnetic pen having a second resonance frequency and sends it to the computer, so that the detections of the electromagnetic pens having the different resonance frequencies are done in turn.

In the present invention, the multi-point touch function of the electromagnetic sensing device is achieved by transmitting the electromagnetic waves at the different frequencies by the electromagnetic sensing board so as to detect the operation information of the electromagnetic pens having the different frequencies. Multiple electromagnetic pens can be cooperatively used, so that it is possible to implement functions such as scaling of pictures or other user-defined functions. As a result, the applications of the electromagnetic sensing board are enriched.

### BRIEF DESCRIPTION OF THE DRAWINGS

FIG. 1 is a structural block diagram showing an electromagnetic sensing device according to an embodiment of the present invention;

FIG. 2 is a flow chart showing the detection of electromagnetic pens having different frequencies by an electromagnetic sensing board according to a first embodiment of the present invention;

FIG. 3 is a diagram showing a data structure sent by the electromagnetic sensing board to the computer according to the first embodiment;

FIG. 4 is a flow chart showing the detection of electromagnetic pens having different frequencies by an electromagnetic sensing board according to a second embodiment of the present invention; and

FIG. 5 is a diagram showing a data structure sent by the electromagnetic sensing board to the computer according to the second embodiment.

### DETAILED DESCRIPTION OF PREFERRED EMBODIMENTS

Hereinafter, the present invention is described in detail with reference to the drawings and embodiments thereof.

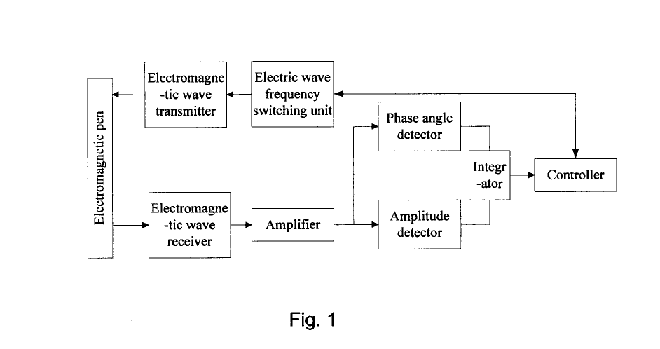

FIG. 1 is a structural block diagram showing an electromagnetic sensing device according to an embodiment of the present invention. The device comprises an electromagnetic sensing board and an electromagnetic pen. The electromagnetic sensing board is adapted to detect trace information inputted by the electromagnetic pen, and has an electromagnetic wave transmitter and an electromagnetic wave receiver, and also a controller, an electric wave frequency switching unit, an amplitude detector, a phase angle detector and an integrator provided therein. The electromagnetic pen is adapted to input the trace, and has a resonance circuit comprised of an inductor and a coil provided therein. The electric wave frequency switching unit generates a square wave, and transmits a electromagnetic wave through the electromagnetic wave transmitter of the electromagnetic sensing board, wherein the electromagnetic wave transmitted through the electromagnetic wave transmitter is a square wave or a sine wave. The transmitted electromagnetic wave causes resonance in the electromagnetic pen, which in turn reflects the electromagnetic resonance wave to the electromagnetic wave receiver of the electromagnetic sensing board. The electromagnetic wave receiver receives the inputted electromagnetic resonance wave, which is amplified by an amplifier and then inputted into the phase angle detector and the amplitude detector respectively for detecting its phase angle and amplitude respectively. The amplified electromagnetic resonance wave signal is integrated and then inputted into the controller. The controller calculates the trace information of the electromagnetic pen such as values of position, tilt angle and pressure based on the received amplified electromagnetic resonance wave signal, and feeds it back to a computer. The controller instructs the electric wave frequency switching unit whether or not to switch the transmitting frequency based on the calculated trace information of the electromagnetic pen. The electric wave frequency switching unit determines whether or not to switch the transmitting frequency based on the instruction from the controller, and feeds the result back to the controller. In this embodiment, the controller has an analog-to-digital (A/D) converter provided therein, and the controller converts the received electromagnetic resonance wave signal into digital signals through the A/D converter for being processed. The A/D converter may be provided separately from the controller, in which case the electromagnetic resonance wave signal having been subject to the integration process is converted into digital signals through the A/D converter, which are then inputted to the controller for being processed.

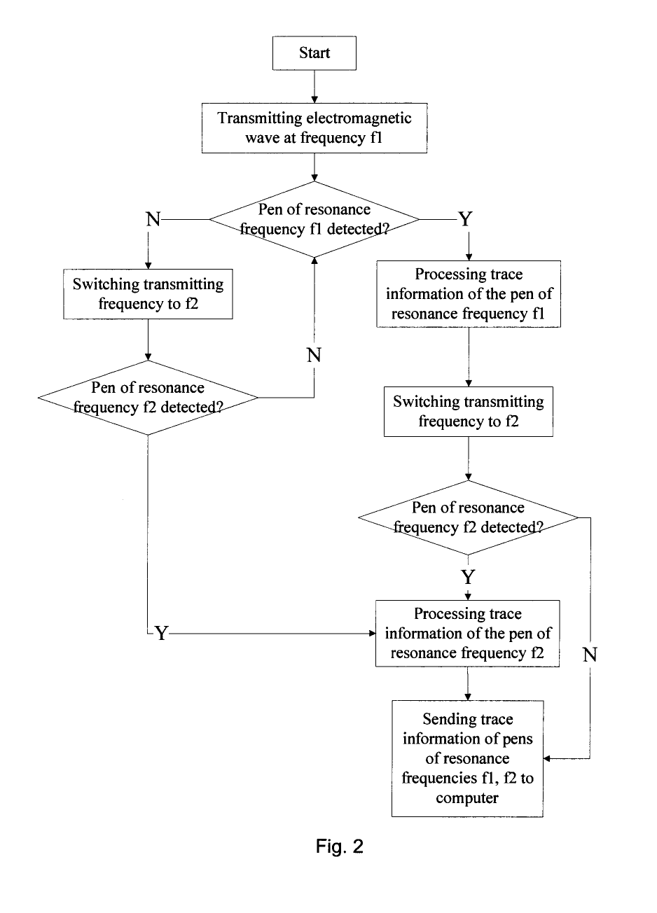

According to a first embodiment of the present invention, the electromagnetic sensing board repeatedly detects electromagnetic pens having different resonance frequencies sequentially, and obtains the trace information of the respective electromagnetic pens having the different resonance frequencies and then sends it to the computer. For convenience of explanation, here two electromagnetic pens having resonance frequencies of f1 and f2 respectively are exemplified. As shown in FIG. 2, the electromagnetic wave transmitter of the electromagnetic sensing board transmits the electromagnetic wave at frequency f1, and thus generates a corresponding electromagnetic field. If the electromagnetic pen having the resonance frequency of f1 is working on the active region of the electromagnetic sensing board, the electromagnetic sensing board detects this electromagnetic pen and calculates the trace information of this electromagnetic pen, such as values of X-direction coordinate, Y-direction coordinate, pressure and tilt angle. When the electromagnetic sensing board completes the detection of the electromagnetic pen having the resonance frequency of f1, it switches the transmitting frequency to f2 whether the electromagnetic pen having the resonance frequency of f1 is detected or not, so as to detect the electromagnetic pen having the resonance frequency of f2 and calculate the trace of this electromagnetic pen. After the electromagnetic sensing board has sequentially detected the electromagnetic pens having the resonance frequencies of f1 and f2 respectively, it sends the trace information of all (both) detected electromagnetic pens to the computer, and then repeats the above flow. For multiple electromagnetic pens having different resonance frequencies, the electromagnetic sensing board also completes the detection with respect to all the resonance frequencies sequentially before it sends the trace information of all detected electromagnetic pens to the computer.

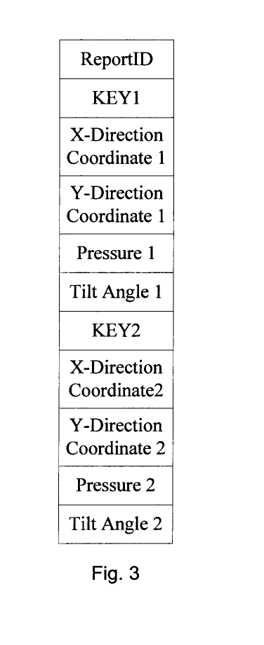

FIG. 3 is a diagram showing the data structure sent by the electromagnetic sensing board to the computer according to the first embodiment. Here, ReportID is provided to inform the computer that this data is handwriting information, and KEY1 is set to indicate key-press information of the electromagnetic pen having the resonance frequency of f1. X-Direction Coordinate 1 and Y-Direction Coordinate 1 refer to the coordinate information of this electromagnetic pen. Pressure 1 refers to the strength by which this electromagnetic pen contacts the active region of the electromagnetic sensing board, and Tilt Angle 1 refers to the angle included between this electromagnetic pen and the plane of the electromagnetic sensing board, that is, the tilt angle of this electromagnetic pen with respect to the active plane of the electromagnetic sensing board. KEY2 is set to indicate key-press information of the electromagnetic pen having the resonance frequency of f2. X-Direction Coordinate 2 and Y-Direction Coordinate 2 refer to the coordinate information of this electromagnetic pen. Pressure 2 refers to the strength by which this electromagnetic pen contacts the active region of the electromagnetic sensing board, and Tilt Angle 2 refers to the angle included between this electromagnetic pen and the plane of the electromagnetic sensing board, that is, the tilt angle of this electromagnetic pen with respect to the active plane of the electromagnetic sensing board. It is possible to arbitrarily set the key-press information of which electromagnetic pens represented by KEY1 and KEY2, as long as they can distinguish between the electromagnetic pens having the different frequencies.

According to a second embodiment of the present invention, the electromagnetic sensing board repeatedly detects the electromagnetic pens having the different resonance frequencies alternately, specifically, detects the trace information of the electromagnetic pen having a first resonance frequency and sends it to the computer before it detects the trace information of the electromagnetic pen having a second resonance frequency and sends it to the computer. Thus, the detections of the electromagnetic pens having the different resonance frequencies are done in turn.

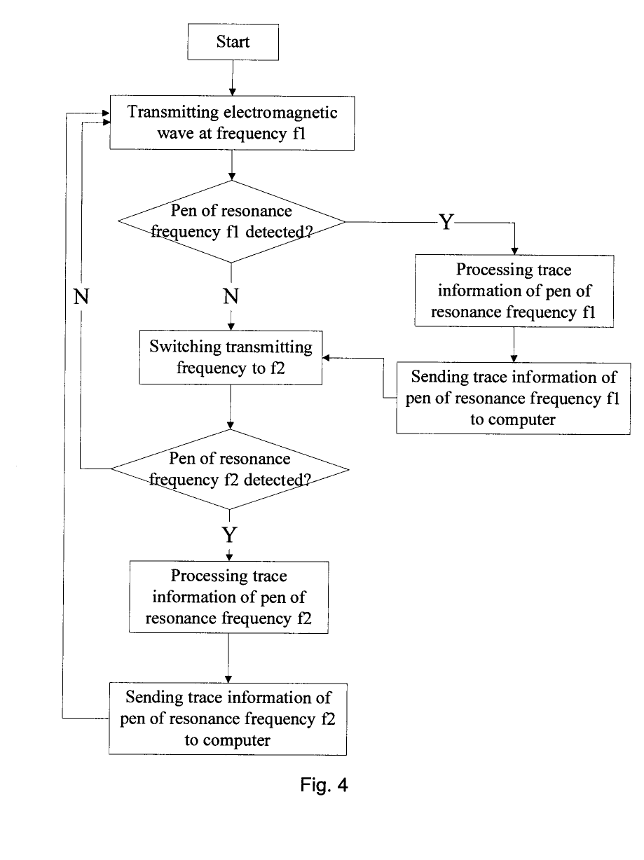

As shown in FIG. 4, in this embodiment, again two electromagnetic pens having resonance frequencies of f1 and f2 respectively are exemplified. The electromagnetic wave transmitter of the electromagnetic sensing board transmits the electromagnetic wave at frequency f1, and thus generates a corresponding electromagnetic field. If the electromagnetic pen having the resonance frequency of f1 is working on the active region of the electromagnetic sensing board, the electromagnetic sensing board detects this electromagnetic pen and calculates the trace information of this electromagnetic pen, such as values of X-direction coordinate, Y-direction coordinate, pressure and tilt angle. The difference from the first embodiment consists in that the electromagnetic sensing board sends the obtained trace information of the electromagnetic pen to the computer before it switches the transmitting frequency to f2 and thus detects the electromagnetic pen having the resonance frequency of f2 and sends the detected information to the computer. If the electromagnetic pen having the resonance frequency of f1 is not detected, then the transmitting frequency is switched to f2. If the electromagnetic pen having the resonance frequency of f2 is detected, then the trace information of this electromagnetic pen is sent to the computer; or otherwise, the transmitting frequency is switched to f1 again. For multiple electromagnetic pens having different resonance frequencies, the detection is also carried out as described above.

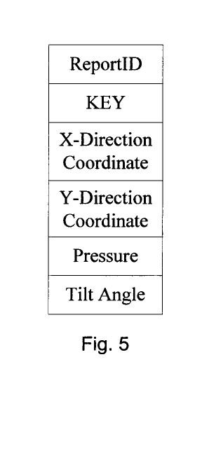

FIG. 5 is a diagram showing the data structure sent by the electromagnetic sensing board to the computer according to the second embodiment. Here, ReportID is provided to inform the computer that this data is handwriting information, and KEY indicates key (such as, right or left key)-press information of the electromagnetic pen. X-Direction Coordinate and Y-Direction Coordinate refer to the coordinate information of the electromagnetic pen. Pressure refers to the strength by which the electromagnetic pen contacts the active region, and Tilt Angle refers to the angle included between the electromagnetic pen and the active plane of the electromagnetic sensing board. The same data structure is adopted for the electromagnetic pens having the different resonance frequencies, which are distinguished by setting the ReportID differently. For example, when ReportID=1 it means the data indicates the trace information of the electromagnetic pen having the resonance frequency of f1, and when ReportID=2 it means the data indicates the trace information of the electromagnetic pen having the resonance frequency of f2.

According to the present invention, it is possible to achieve a wireless and passive electromagnetic sensing device having the multi-point touch function by quickly switching the transmitting frequency of the electromagnetic sensing board. With this device, it is possible not only to conveniently input information such as coordinate, pressure and tilt angle of the electromagnetic pen by the user, but also to achieve cooperation of multiple electromagnetic pens so as to implement functions such as scaling of pictures or other user-defined functions. As a result, the applications of the electromagnetic type sensing board are enriched.

1. An electromagnetic sensing device having a multi-point touch function, comprising electromagnetic pens and an electromagnetic sensing board, each of the electromagnetic pens having a resonance circuit provided therein, and the electromagnetic sensing board having an electromagnetic wave transmitter, an electromagnetic wave receiver, a controller and an electric wave frequency switching unit provided therein, wherein:
the electric wave frequency switching unit of the electromagnetic sensing board receives an instruction from the controller to control the electromagnetic wave transmitter to transmit electromagnetic waves at different frequencies,
the electromagnetic pens generate electromagnetic resonance waves at respective resonance frequencies, and
the electromagnetic receiver receives the electromagnetic resonance waves at the respective resonance frequencies so that the controller detects trace information of the electromagnetic pens having the respective resonance frequencies.

2. The electromagnetic sensing device according to claim 1, wherein the electromagnetic sensing board further has an amplifier, a phase angle detector, an amplitude detector and an integrator provided therein, and
wherein the electromagnetic wave receiver receives the electromagnetic resonance waves reflected from the electromagnetic pens respectively, and
the received electromagnetic resonance waves are amplified by the amplifier to be inputted to the phase angle detector and the amplitude detector respectively for detecting their respective phase angles and amplitudes, and then inputted through the integrator to the controller, which detects the trace information of the respective electromagnetic pens and sends it to a computer.

3. The electromagnetic sensing device according to claim 1, wherein the electromagnetic sensing board repeatedly detects the electromagnetic pens having the different resonance frequencies sequentially, and obtains the trace information of the respective electromagnetic pens having the different resonance frequencies before sends it to the computer.

4. The electromagnetic sensing device according to claim 3, wherein the electromagnetic sensing board detects the electromagnetic pens having the resonance frequencies of f1 and f2 respectively,
the electromagnetic wave transmitter transmits the electromagnetic wave at the frequency f1, and the controller detects the trace information of the electromagnetic pen having the resonance frequency of f1,
the electromagnetic wave transmitter transmits the electromagnetic wave at the frequency f2, and the controller detects the trace information of the electromagnetic pen having the resonance frequency of f2, and
the controller sends the detected trace information of the electromagnetic pens having the resonance frequencies of f1 and f2 respectively to the computer.

5. The electromagnetic sensing device according to claim 1, wherein the electromagnetic sensing board repeatedly detects the electromagnetic pens having the different resonance frequencies alternately, and
the electromagnetic sensing board obtains the trace information of the electromagnetic pen having a first resonance frequency and sends it to the computer before it obtains the trace information of the electromagnetic pen having a second resonance frequency and sends it to the computer, so that the detections of the electromagnetic pens having the different resonance frequencies are done in turn.

6. The electromagnetic sensing device according to claim 5, wherein the electromagnetic sensing board detects the electromagnetic pens having the resonance frequencies of f1 and f2 respectively,
the electromagnetic wave transmitter transmits the electromagnetic wave at the frequency f1, and the controller detects the trace information of the electromagnetic pen having the resonance frequency of f1 and sends the obtained trace information of this electromagnetic pen to the computer, and switches the transmitting frequency of the electromagnetic wave to f2 if the electromagnetic pen having the resonance frequency of f1 is absent, and
the electromagnetic wave transmitter transmits the electromagnetic wave at the frequency f2, and the controller detects the trace information of the electromagnetic pen having the resonance frequency of f2 and sends the obtained trace information of this electromagnetic pen to the computer, and switches the transmitting frequency of the electromagnetic wave to f1 if the electromagnetic pen having the resonance frequency of f2 is absent.
